(19) United States
(12) Patent Application Publication
(10) Pub. No.: US 2011/0271350 A1
(43) Pub. Date: Nov. 3, 2011

(54) METHOD FOR PROTECTING SOFTWARE

(75) Inventors: Zhou Lu, Beijing (CN); Huazhang Yu, Beijing (CN)

(73) Assignee: Feitian Technologies Co., td., Beijing (CN)

(21) Appl. No.: 12/921,403

(22) PCT Filed: Jul. 23, 2010
(86) PCT No.: PCT/CN10/75448

§ 371 Date: Sep. 8, 2010

(30) Foreign Application Priority Data
Apr. 28, 2010 (CN) 201010163378.5

(51) Int. Cl. G06F 21/00; G06F 9/45; G06F 9/44

(52) U.S. Cl. 726/26

(57) ABSTRACT

A method for protecting software is disclosed in the invention, including steps of analyzing the software or obtaining source codes of the software, and modifying the instructions obtained from analyzing the software or source codes of the software, and programming the modified instructions or compiling the modified source codes to obtain new software and ending or going on running the rest of instructions according to the result of executing the new instructions. By executing this method, the software is protected.

### FIELD OF THE INVENTION

The invention relates to the computer field, in particular to a method for protecting software.

### PRIOR ART

With the continuous development in computer field, needs for software in different industry emerge. However, the loss will be difficult to evaluate when software is theft or illegally copied, which not only discourages the software developer, but also encourages privacy.

### SUMMARY OF INVENTION

For eliminating the disadvantages of the above mentioned, a method for protecting software is disclosed in the invention, comprising

analyzing the software, obtaining all instructions of the software, modifying part of the instructions, obtaining new instructions, programming the modified software, and getting new software; and the new software ending or going on execution according to the result of running the modified instructions;

or acquiring source codes of the software, modifying part of the source codes, obtaining the modified source codes, compiling the modified source codes, generating new software, and running the software; and the new software ending or going on execution according to the result of running the modified source codes.

### ADVANTAGES

In the invention, the software is protected by inserting information security codes into the software, or replacing part instructions of the software, or encrypting part instructions of the software, or modifying part function name of the software, or storing part instructions in external environment for execution, or running part instructions of the software and storing the result to external environment.

### BRIEF DESCRIPTION OF THE DRAWINGS

FIG. 1 is the flow chart in embodiment 1 of the method for protecting software according to the invention;

FIG. 2 is the flow chart in embodiment 1 of running the protected software according to the invention;

FIG. 3 is the flow chart in embodiment 2 of the method for protecting software according to the invention;

FIG. 4 is the flow chart of running the protected software in embodiment 2 according to the invention;

FIG. 5 is the flow chart of a method for protecting software in embodiment 3 according to the invention;

FIG. 6 is the flow chart of running the protected software in embodiment 3 according to the invention;

FIG. 7 is the flow chart of a method for protecting software in embodiment 4 according to the invention;

FIG. 8 is the flow chart of a method for protecting software in embodiment 5 according to the invention;

FIG. 9 is the flow chart of running the protected software in embodiment 5 according to the invention;

FIG. 10 is the flow chart of a method for protecting software in embodiment 6 according to the invention;

FIG. 11 is the flow chart of running the protected software in an embodiment 6 according to the invention;

FIG. 12 is the schematic diagram of inserting instructions by software in an embodiment 1 according to the invention.

### DETAILED DESCRIPTION OF THE PREFERRED EMBODIMENTS

A clear description will be given below for the preferred embodiments of the invention in combination with the drawings, and the description is not a limit to the invention, but a convenience for those skilled in prior art to understand solutions of the invention.

### Embodiment 1

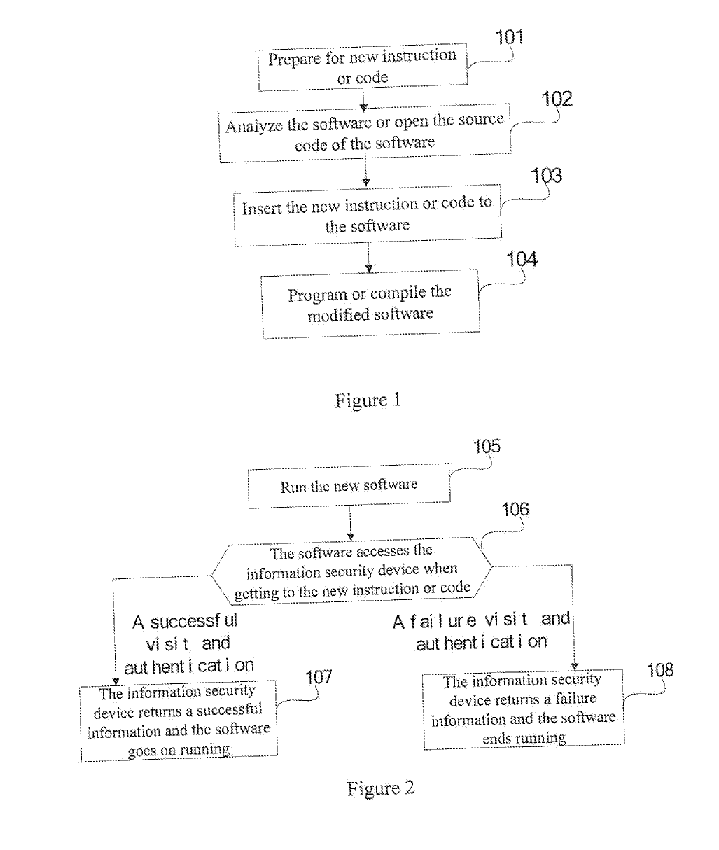

Shown as in FIG. 1, a method for protecting software is disclosed in the invention, including

Step 101: preparing for new instructions or codes;

The new instructions or codes refer to the information security instructions or codes to be inserted into the software, wherein the instructions are programmed with low-level assembly language and the codes are programmed with high-level programming language.

The new instructions or codes may include the instruction or code for accessing the information security device, information of the hardware loading the software, that will be written to the information security device, and the instruction or code requiring the information security device to determine the information of the hardware loading the software, the instruction or code for requiring the information security device to return the determining result.

The information of the hardware loading the software is pre-stored in the information security device, and therefore the device determines whether a match is found upon receiving the written information and returns the determining result to the software.

The new instructions or codes may include the instruction or code for accessing the information security device, the log-on information and password which will be written to the information security device, the instruction or code requiring the information security device to determine whether the log-on information and password are correct, and the instruction or code requiring the information security device to return the determining result. The log-on information and password is pre-stored in the information security device, and therefore the device determines whether a match is found upon receiving the written information and returns the determining result to the software.

The new instructions or codes may include the instruction or code for accessing the information security device, the hardware features of the information security device which will be written to the information security device, and the instruction or code requiring the information security device to determine whether the hardware features are correct, and the instruction or code requiring the information security device to return the determining result.

The hardware features of the information security device are pre-stored in the software, and therefore the device determines whether a match is found upon receiving the hardware features written by the, software, and returns the determining result to the software.

Step 102: loading and analyzing the software, or opening the source codes of the software.

For the new instructions prepared in the step 101, the software needs loading and analyzing.

Commonly, software is comprised of more parts, such as data, stack, instruction, resource and etc. The analyzing process is described as follows. A PE file starts with a DOS header, and by analyzing the DOS header, the PE header file is acquired, and by analyzing the PE header file, the description of the PE file is obtained, that is comprised of the starting address of the instruction part. So the instruction part is obtained with the address. All offset address and length of the instruction part are included in the description information of the instruction part, and therefore all instructions and functions in the instruction part are located.

Analyzing the software is for locating the instructions and functions in the instruction part.

For another type of software, the analyzing process is the same with what above mentioned.

For the new codes prepared in the step 101, the process of opening the source codes of the software is a process of opening the software with a program and obtaining the source codes programmed with a high-level language.

Step 103: inserting the new instructions or codes to the original software, and therefore the new instructions or codes will be executed when running the modified software.

The instructions prepared in the step 101 is inserted to anywhere between two instruction segments, or inside any instruction segment of the software, such as anywhere between two function modules or inside any function module, and therefore the new instructions or codes will be executed when running the modified software.

The codes prepared in the step 101 are inserted to the software.

Step 104: programming the software with the new instructions and obtaining new software; or compiling the software with the new codes, obtaining new software, and storing the new software.

Programming the software with the new instructions is changing address of the inserted instructions of the software and thereafter, according to the address and length of the new inserted instructions, which makes the new software run correctly.

The below is an example of the process from step 101 to step 104, wherein the software is comprised of two instruction segments A1 and A2, and the new instruction A3 is inserted between A1 and A2. Firstly, the ending address of A1 is obtained by the starting address and length of A1, and A3 is inserted to the address next to the ending address of A1, and the ending address of A3 is obtained by the starting address and length of A3, and A2 is added to the address next to the ending address of A3. Correspondingly, the length of software A needs changing, the A3 needs inserting, and the offset address and length of A2 need changing.

FIG. 2 is a flow chart of running the protected software in the embodiment of the invention.

Step 105: running the new software.

Step 106: when the new instructions or codes are executed, the software automatically accesses the information security device, if it succeeds in the accessing to the device, go to step 107; or else, go to step 108.

In the embodiment, the information security device is a separate peripheral for storing, computing, encryption and decryption.

Upon obtaining to the new instructions, the software accesses the information security device. In details it is that the software requires the device storing it, to visit the information security device, and writes the log-on information and password, or its features or hardware feature written in step 101, to the information security device; and the information security device compares the received information to the information pre-stored, if a match is found, it means a successful access to the device and the step 107 is executed; or else, it means a failed access and the step 108 is executed.

The information security device pre-stores the time information of the software accessing the information security device, which includes a special time period or any time period of accessing the information security device by the software, once the software accessed the information security device over or off the predestined time period, the access is interrupted and the step 108 is executed; or else, the access is continued and the step 107 is executed.

After the software writes the log-on information or password to the information security device, if the device confirms the information correct, the software succeeds in the visit and the step 107 is executed.

After the software writes the hardware features to the information security device, the information security device compares the pre-stored information with the received information, if a match is found, the step 107 is executed; or else, the step 108 is executed.

Step 107, upon receiving the successful visit information from the information security device, the software goes on executing the rest instructions till the end.

Step 108, upon receiving the visit failure information from the information security device, the software ends running.

Referring to FIG. 12, an example of inserting the prepared instructions to the software is provided, wherein the software A is comprised of segment A1 and segment A2. The added instructions are inserted instructions in the figure. Due to the insertion, the address of the segment A2 changes, and therefore the starting address and the offset address of A2 need modifying which ensures the same result obtained from running the original software and the new software.

Advantage: the software is protected by inserting an authentication and calling instruction to the software in the embodiment.

### Embodiment 2

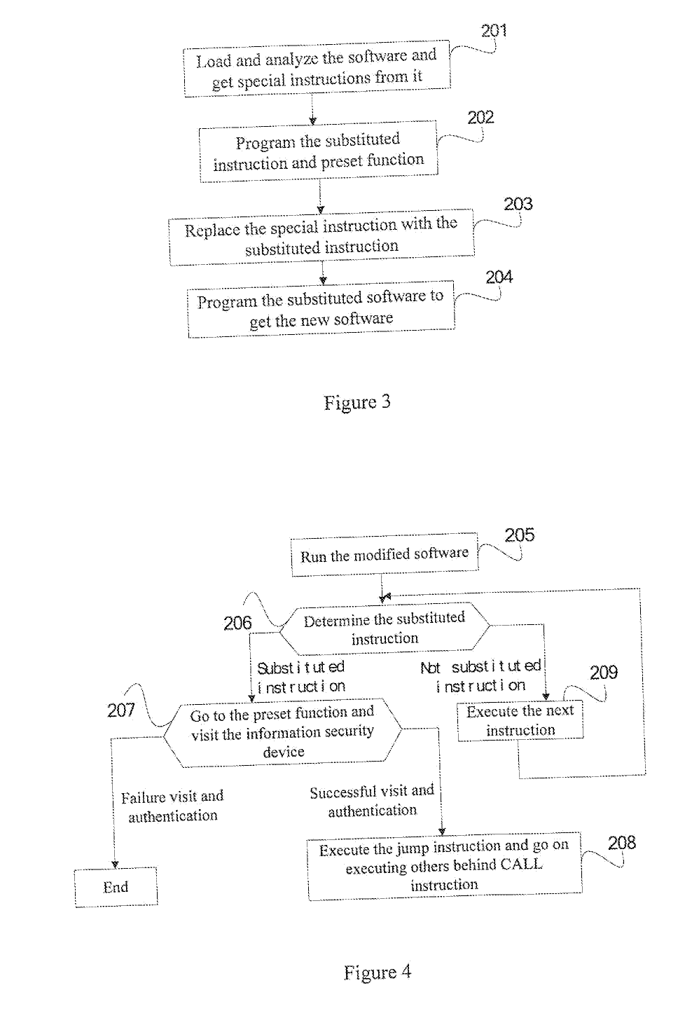

Shown as in FIG. 3, a method for protecting software is further disclosed, including steps as follows.

Step 201, loading and analyzing software, and obtaining special instruction from it.

Analyzing the software is for obtaining the special instruction from it. The process of the obtaining the special instruction is the same with that in step 102, that is, firstly obtaining the address and length of all instruction segments and functions, and secondly locating the special instruction.

Step 202, programming substituted instruction and preset function with the special instruction.

The substituted instruction is for replacing the special instruction of the software, such as the jump set. In the embodiment, the substituted instruction is CALL instruction for calling the preset function. There, are two types of preset functions.

One type of the preset function includes the instruction for accessing the information security device, the information that is written to the information security device (including identification of the information security device, time period for accessing the information security device or information for communicating with the information security device), the jump set, and the instruction for executing the jump set and the instructions behind CALL instruction of the software.

The software running the first type of preset function is that the software calls the preset function when getting to the CALL instruction, automatically accesses the information security device, writes information to the device for confirmation, and after a successful confirmation is obtained from the device, the software returns to the function and goes on running till all instructions are executed.

Another type of the preset function includes the instruction for accessing the information security device, the information that is written to the device (including identification of the information security device, time period for accessing the information security device or information for communicating with the information security device), the jump set, the instruction for requiring the device to execute the jump set, the instruction for requiring the device to return the execution result, and the instruction for executing the instructions behind the CALL instruction.

The new software running the second type of preset function is that the software calls the preset function when getting to the CALL instruction, automatically accesses the information security device, sends the information (including identification of the information security device, time period for accessing the information security device or information for communicating with the information security device) and the jump set to the information security device after a successful visit to the device, executes the jump set after a successful authentication for the written information by the information security device, returns the result to the Call instruction, and goes on execution the rest instructions till the end upon receiving the execution result by the CALL instruction.

Step 203: replacing the special instruction with the substituted instruction.

Call instruction points to the preset function prepared in the step 202.

Step 204: programming the software with the substituted instruction, getting new software, and storing the new software and the preset function.

The programming is that computing and storing the new address and length of the modified software with the substituted instruction, and changing the address of the instructions behind the substituted instruction, which ensures that the result obtained after running the original software is the same with the result of running the modified software.

The below is an example for the process of replacing the special instruction with the substituted instruction and creating the preset function, including

analyzing the software, obtaining four special instructions A, B, C and D from it, extracting the special instruction B for programming a preset function W, and replacing the blank left by B with the instruction CALL W for calling the preset function W directly. Two types of the preset function W have been described above. So the modified software includes four parts, A, CALL W, C and D. Due to the difference between the instruction B and the CALL W in length, the address of C and D needs changing for ensuring that the result of running the original software is same with the new software.

In the invention, the software can include more special instructions for substitution, and the process of the substitution is the same as that described above.

FIG. 4 is a flow chart of running the protected software in the embodiment 2 of the invention.

Step 205: running the new software obtained in step 204, this means that executing all instructions of the software.

Step 206: determining whether the instruction being executed is a substituted instruction, if it is, go to step 207; or else, go to step 209.

Step 207: getting to the preset function, accessing the information security device, writing the information (identification of the information security device, time period for accessing the information security device or information for communicating with the information security device) to the device, and going to step 208 after a successful visit or ending the running after a failed visit.

The process of the preset function accessing the information security device is the same with that in step 106 of embodiment 1.

Step 208: going on running the jump set in the preset function, returning to the software and executing the instructions behind the CALL instruction till the end.

Step 209: executing the next instruction, and returning to step 204.

Advantage:

The software is protected by replacing the special instruction with the substituted instruction in the embodiment.

### Embodiment 3

Shown as in FIG. 5, a method for protecting software is also disclosed in the invention, comprising

Step 301: loading software.

Step 302: analyzing the software and obtaining at least one instruction segment for encryption.

Analyzing the software is for acquiring address of all instructions of the software with the same process, as that in step 102 of the embodiment 1, of locating each segment and function of the software according to the offset address and length of the segment and function of the software.

Encrypting the instruction segment can be completed with RSA algorithm, SHA1 algorithm, 3-DES algorithm or AES algorithm.

Step 303: programming the preset function with the encrypted instruction segment, storing the preset function to external environment, and replacing the blank, left by the encrypted segment, with a function index instruction.

The external environment comprises external software environment, hardware environment or virtual environment.

The function index instruction points to the preset function. There are three types of preset function.

The first type of preset function comprises the encrypted segment, and the instruction for decrypting the encrypted segment, the instruction for executing the decrypted segment, and the instruction for determining whether to go on running or end the software according to the result of executing the decrypted segment.

The second type of preset function comprises the encrypted instruction segment, the instruction for writing the preset hardware features to the information security device, the instruction for extracting the decryption key from the information security device, the instruction for decrypting the encrypted segment with the decryption key, the instruction for executing the decrypted segment and the instruction for determining whether to go on running or end the software according to the result of executing the decrypted segment.

The third type of the preset function comprises the encrypted instruction segment, the instruction for accessing and authenticating the information security device, the instruction for writing the encrypted segment to the information security device after a successful authentication by the device, the instruction for requiring the information security device to decrypt the encrypted segment and to execute the decrypted segment and to return the execution result, and the instruction for determining whether to go on running or end the software according to the execution result.

The step 303 can be a step of programming the preset function with the encrypted instruction segment, and replacing the original instruction segment with the preset function.

Step 304: programming the modified software, getting new software, and storing the new software and the encrypted instruction segment.

In the step, the process of programming the modified software is that changing the address of the instructions behind the encrypted instruction segment, which is the same as that in step 104 of the embodiment 1.

If the step 303 is a step of programming the preset function with the encrypted instruction segment, and replacing the preset function with the encrypted instruction segment, the step 304 is a step of changing the address of the instructions behind the preset function which ensures that the result of running the original software is same with the result of the new software.

The below is an example of the Process of inserting the function index instruction.

The software in the example comprises five parts of instruction segments A, B, C, D and E, and the software protection process is that analyzing the software, obtaining the segment C for encryption, creating a function with the encrypted segment C, storing the function in external environment, generating a function index instruction X with the function w, obtaining the function index instruction X pointed to the address of w, replacing the blank left by the segment C with the function index instruction X, and getting new software with segments A, B, X, D and E. Due to the difference of the segment C and the function index instruction X in length, it is necessary to program the address of the segments C and D behind X, which ensures that the result of running the original software is same with the result of the new software. The three types of X have been described above, and no further detail is given here.

Moreover, in the invention, more segments can be chosen for encryption at the same time, and be stored. For example, both B and C are chosen for encryption, correspondingly functions w1 and w2 are generated with the encrypted segments separately and stored in external environment, and the blank left by B and C are replaced with X1 and X2 to get the new software with segments A, X1, C, X2 and E wherein X1 pointing to the address of w1 and X2 pointing to the address of w2. The three types of X1 or X2 have been described above.

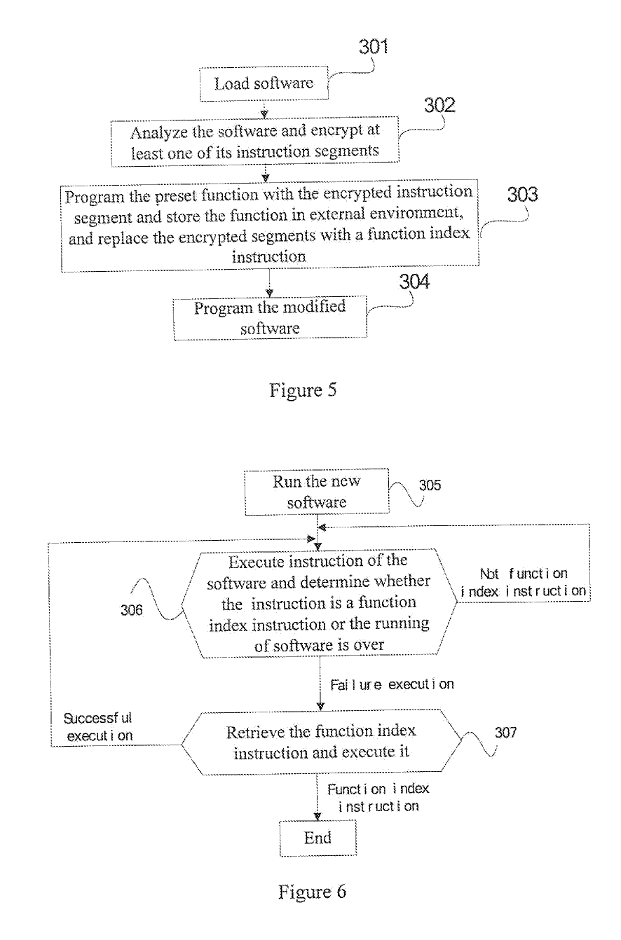

FIG. 6 is the flow chart of running the protected software disclosed in the embodiment of the invention.

Step 305: running the new software;

Step 306: running instructions of the new software one by one, determining whether the instruction being executed is a function index instruction or the software is over, if the instruction being executed is a function index instruction, goes to step 307; if the instruction being executed is not a function index instruction, going to the next instruction and returning to step 306; and if the software is over ending execution of all the rest instructions.

If the step 303 is a step of programming the preset function with the encrypted segment and replacing the encrypted segment with the preset function, the step 306 is a step that the software automatically executes the preset function and the instructions behind the function till the end.

Step 307: retrieving the preset function with the function index instruction, and executing the preset function, if the execution is successful, returning to the software, going to the next instruction and returning to step 306; or else, ending execution of the rest instructions.

In the step, executing the preset function refers to executing one of the above described three types of the preset functions.

For the first type of preset function, the execution is extracting the encrypted segment, decrypting the encrypted segment, and executing the decrypted segment, if the execution is successful, going to the next instruction of the software and returning to step 306; and or else ending execution of all the rest instructions.

For the second type of preset function, the execution is extracting the encrypted segment from the software, writing the hardware features of the information security device to the pre-bound information security device, obtaining the decryption key from the information security device if the security device confirms that the hardware features is correct, decrypting the encrypted segment with the decryption key, executing the decrypted segment, returning to the next instruction of the software and going to step 306 after a successful execution or ending execution of the rest instructions after a failure execution.

For the third type of preset function, the execution is extracting the encrypted segment, writing the pre-stored hardware features of the information security device to the pre-bound information security device, writing the encrypted segment to the information security device after a positive confirmation by the information security device, decrypting the encrypted segment, executing the decrypted segment, returning the execution result to the preset function by the information security device, and returning to the new software according to the execution result.

Advantage:

In the embodiment of the invention, the software is protected by replacing part of the instruction segments of the software with the function index instruction.

### Embodiment 4

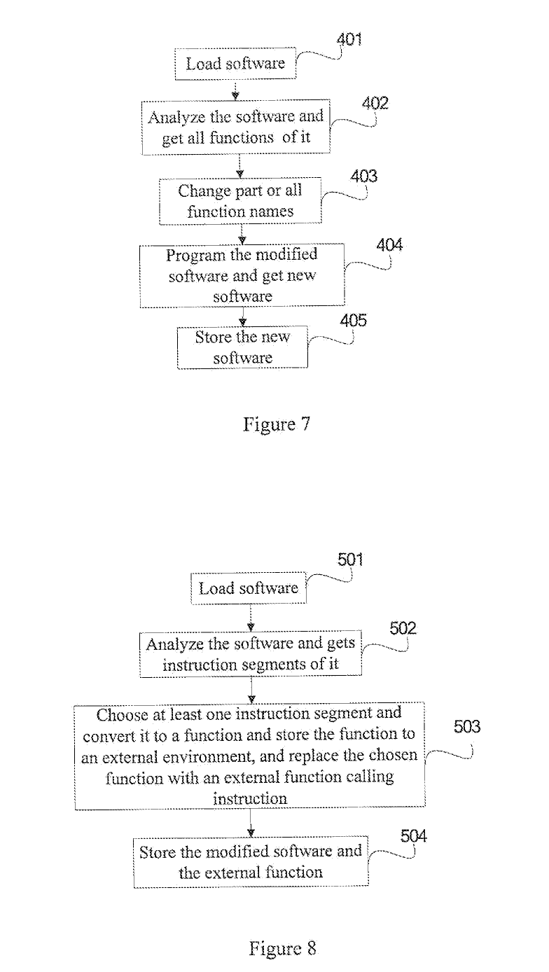

Shown as in FIG. 7, a method for protecting software is disclosed in the invention, comprising

Step 401, loading software;

Step 402, analyzing all functions and instructions of the software to obtain the easy-to-be identified name of CLASS, Name Space name or variable name.

The step of the analyzing is the same as that in step 102 in embodiment 1.

When developing software, most developers are used to define function name with function description, such as encryption module, that is surely unsafe to the software, and thus part or all function names need to be changed to protect the software.

Besides the function name, there still exist other names easy to be identified, like name of Class, Name Space name or variable name, which can all be obtained in the analyzing step.

Step 403, changing the name of Class, Name Space name, function name or variable name which are easy to be identified. For example, the program changes the function name from encryption module to e_{—}123, and therefore the function name makes no sense to the function.

Step 404, programming the software after the above changes in the name of class, name space or function to get new software.

Due to the change of function names in length, it is a must to program the address of the modified functions.

Step 405: storing the modified software.

In the invention, the process of running the protected software is simple, and no further detail is given here.

Advantage:

In the embodiment of the invention, the software is protected by changing function name of the software because the function name is hard to be understood just by the name and sometimes the name is mixed with other names such as class name and number.

### Embodiment 5

Shown as in FIG. 8, a method for protecting software is also disclosed in the invention, comprising

Step 501: loading software.

Step 502: analyzing the software to obtain all instructions with the same step as that in step 102 of the embodiment 1.

Step 503: choosing one or more instructions, converting them to one or more functions, storing the function or the functions in external environment, and replacing the chosen instructions with one or more CALL instructions.

In the step, one or more instructions can be chosen, and correspondingly one or more functions are obtained and stored in external environment, and the instruction is replaced with a CALL instruction. The external environment comprises external software environment, hardware environment or virtual environment.

The external function comprises the instruction for executing the chosen instructions, the instruction for returning the result of executing the chosen instructions, or the instruction for executing the chosen instructions and the instruction for returning the result of executing the chosen instructions to the new software.

In the invention, one or more instructions can be chosen and converted to one or more functions for replacing one or more instructions.

Step 504: programming the modified software, getting new software, and storing the new software and the external function.

The process of the programming is the same as that in step 104 in the embodiment 1.

If one or more instruction segments are chosen and converted to one or more functions for the replacing in step 503, it programs the address of the instructions behind the functions in the software in step 504 which leads to the result of running the new software which is same with the result of running the original software.

The below is an example for extracting part of instruction segments from the software and converting them into external functions, that is analyzing the software, obtaining five instruction segments A, B, C, D and E, extracting the instruction segment B from the obtained segments, converting B into an external function, storing the external function in external software, hardware or virtual environment, replacing the blank left by the instruction segment B with a function calling instruction, such as Call B, and getting the new software comprised of A, Call B, C, D and E. Due to replacing the instruction segment B with the function calling instruction, the segment B is different from the function calling instruction in length and therefore modification should be made to the address of the instruction segments C, D and E.

It is possible that more instructions segments are included in the software in the invention, and more segments are extracted from the software, but the process of the replacing and modification is the same as what described above.

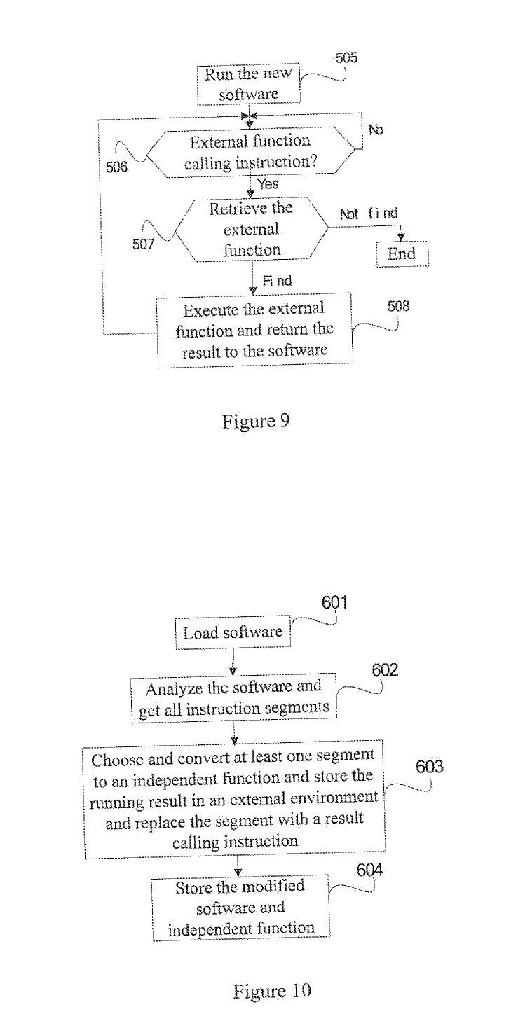

FIG. 9 is a flow chart of running the protected software in the embodiment 5 in the invention.

Step 505: running the new software.

Step 506: determining whether there is an external function calling instruction in the software or the software is over, if there is an external function calling instruction, going to step 507; if there is not an external function calling instruction, going to step 506; and if the software is over, ending execution of the rest of instructions.

If one or more instruction segments are chosen and converted to one or more functions for the replacing in step 503, the software automatically runs the replaced function upon getting to the substituted functions and goes on running the rest instructions till the end of the software.

Step 507: retrieving the external function with the address the external function calling instruction refers to, if it does, going to step 506; or else, ending all execution of the rest of the instructions.

Advantage:

In the embodiment, the software is protected by replacing part of instructions of the software with a function calling instruction created by the replaced instructions.

### Embodiment 6

Shown as in FIG. 10, a method for protecting software is disclosed in the invention, including steps as follows.

Step 601: loading software.

Step 602: analyzing the software for obtaining all instruction segments with the same process as that in step 102 of the embodiment 1.

Step 603: choosing one or more instruction segments, converting the one or more instruction segments to one or more independent functions, running the one or more independent functions, storing the running result in external environment for calling by the software, and replacing the chosen instruction segments with a running result calling instruction.

In the step, one instruction segment is converted to one independent function, and more instructions are converted to more independent instructions. The independent function is a function that is able to run for a result directly.

In the embodiment, the external environment comprises external software, hardware or virtual environment.

Step 604: programming the software with the inserted running result and getting new software with the same process as that in step 104 of embodiment 1.

If one or more instruction segments are chosen and converted to one or more independent functions and replaced with the result of running the converted independent functions in the step 603, the process of programming is that modifying the address of the instructions behind the chosen instruction segments, that makes the result of running the original software same with the result of running the new software.

The below is an example for the process of extracting the instruction segments from the software and converting them to the independent functions, and running the independent functions and storing the running result to external environment. The process in the example is that analyzing the software, obtaining four instruction segments A, B, C and D, extracting the instruction segment B, converting B to an independent function, running the independent function to get a result, storing the result in external software, hardware or virtual environment, and replacing the blank left by the chosen instruction segment B of the software with a result calling instruction CALL x. After the process, the software is comprised of four parts, separately A, CALL x, C and D. Comparing to the instruction segment B, the substitution of result calling instruction CALL x changes in length, and therefore the address of the instruction segments C and D need changing.

Of course, more instruction segments can be chosen and processed with the above-mentioned steps, and therefore it is eliminated.

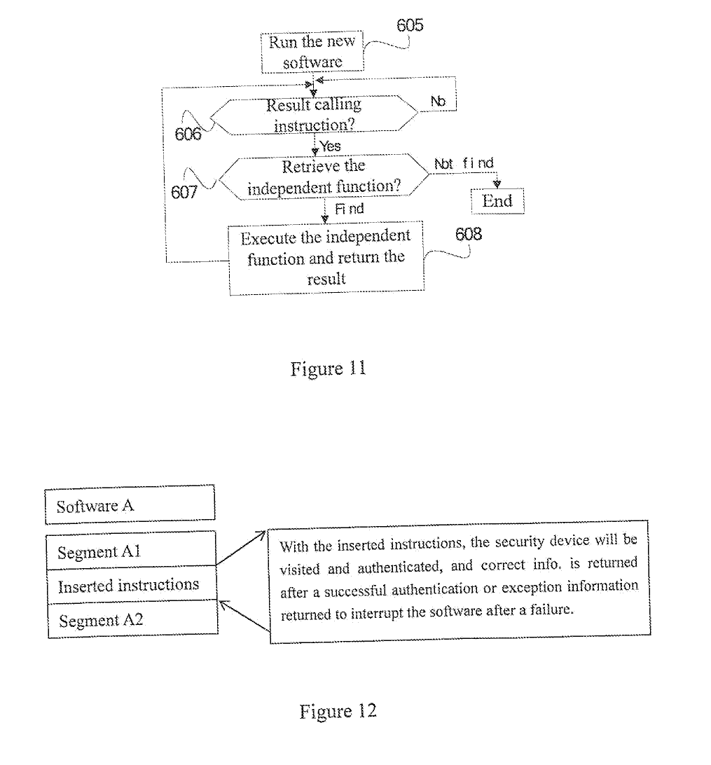

FIG. 11 is a flow chart of running the protected software in the invention.

Step 605: running the new software;

Step 606: determining whether there is an independent function calling instruction in the software or whether the software is over, if there is, going to step 607; if there is not, going to step 606; and if the running of the software is over, getting the end.

If one or more instructions are chosen and converted to one or more independent functions in step 603, the step 606 is running the one or more independent functions separately, replacing the chosen one or more instructions with one or more results of running the one or more independent functions, and running the instructions next when getting to the one or one results till the end of software.

Step 608: determining whether there is an independent function in software, if there is, going to step 606, and or else, ending executing the rest instructions.

Advantage: in the embodiment, the software is protected by running part instruction segments of the software independently and storing the running result to external environment due to the incompletion of the software.

The above embodiments are only for understanding the method and principles of the invention, and for those skilled in prior art, any modification made to the embodiments and application thereof is acceptable. In all, the content of the specification is not a limit to the invention.

1. A method for protecting software, comprising
analyzing the software, obtaining all instructions of the software, modifying part of the instructions, obtaining new instructions, programming the modified software, and getting new software; and the new software ending or going on execution according to the result of running the modified instructions;
or obtaining the source codes of the software, modifying part of the source codes, obtaining the modified source codes, compiling the modified source codes, generating new software, and running the new software; and the new software ending or going on execution according to the result of running the modified source codes.

2. The method of claim 1, wherein analyzing the software is obtaining the starting address of all instructions and functions with the description of offset address and length of all instructions and functions.

3. The method of claim 1, wherein obtaining the source codes of the software is opening the source codes of the software.

4. The method of claim 1, wherein modifying part of the instructions is inserting information security instructions into anywhere between or inside the instructions.

5. The method of claim 1, wherein modifying part of the source codes of the software is inserting information security codes to the sources codes.

6. The method of claim 5, wherein the information security codes are used for accessing an information security device and for authenticating the information security device mutually.

7. The method of claim 1, wherein modifying the instructions obtained from analyzing the software is replacing the special instructions of the software with substituted instruction, programming a preset function with the special instruction, and storing it in external environment, wherein the substituted instruction is used for calling the preset function.

8. The method of claim 7, wherein programming the modified instructions is programming the offset address of the modified instructions which ensures the same result being obtained from running the software before and after the modification.

9. The method of claim 7, wherein the preset function comprises the instruction for accessing the information security device, the information and special instructions for being written to the information security device, the instruction for executing the special instructions, and the instruction for returning to the software and going on running the instructions behind the special instructions.

10. The method of claim 7, wherein the preset function comprises the instruction for accessing the information security device, the information for being written to the information security device, the special instructions, and the instruction for requiring the information security device to execute the special instructions and to return to the software for executing the instructions behind the special instructions.

11. The method of claim 1, wherein the program modifying the instructions of the software is that the program encrypts part instructions of the software, programs a function with the encrypted instructions, stores the function in external environment, and replaces the encrypted instructions with function index instruction for calling the function.

12. The method of claim 11, wherein the function called by the function index instruction comprises the encrypted instructions, the instruction for decrypting the encrypted instructions, the instruction for executing the decrypted instructions and the instruction for ending or going on running the software.

13. The method of claim 11, wherein the function called by the function index instruction comprises the instruction for obtaining the key for decrypting the encrypted instructions from the pre-bound information security device, the instruction for executing the decrypted instructions and the instruction for ending or going on running the software according to the result of executing the decrypted instructions.

14. The method of claim 11, wherein the function called by the function index instruction comprises the instruction for accessing the information security device, the instruction for writing the encrypted instructions to the information security device after a successful accessing by the information security device, the instructions for decrypting the encrypted instructions and executing the decrypted instructions and returning the execution result to the function index instruction by the information security device, and the instruction for ending or going on running the software by the function index instruction according to the returned execution result.

15. The method of claim 1, wherein modifying the instructions is modifying the Class name, space name, function name or variable name of the instructions.

16. The method of claim 1, wherein modifying the instructions is storing part of the instructions in external environment, and replacing the blank left by the part of instructions with an instruction calling instruction.

17. The method of claim 1, wherein modifying part of the instructions is obtaining part of the instructions of the software, storing them to external environment, and replacing the blank left by the modified instructions with the running result calling instruction.

18. The method of claim 17, wherein the external environment comprises external software, hardware or virtual environment.
